(19) United States
(12) Patent Application Publication
(10) Pub. No.: US 2005/0207600 A1
(43) Pub. Date: Sep. 22, 2005

(54) Speaker

(75) Inventors: Teruo Mori, Tokyo (JP); Nobuo Kaihara, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/070,260

(22) Filed: Mar. 3, 2005

(30) Foreign Application Priority Data
Mar. 22, 2004 (JP) 2004-083603

(51) Int. Cl. H04R 25/00

(52) U.S. Cl. 381/152; 381/431

(57) ABSTRACT

A speaker has a vibration device disposed under a floor approximately in the shape of a board, which can vibrate in the direction of thickness. The floor can vibrate at least around the vibration device. Since the vibration device vibrates the floor, sound is emitted from a floor surface, and hence the sound is transmitted to a wide area above the floor surface.

### BACKGROUND OF THE INVENTION

1. Field of the Invention

The present invention relates to a speaker, and especially relates to a speaker which can save installation space and transmit sound to a wide area.

2. Description of the Related Art

A conventionally known speaker 1 as shown in FIG. 6 comprises a drive rod 5, a magnetic field generation coil 6, and a diaphragm 7 (refer to Japanese Patent Laid-Open Publication No. 10-145892). The drive rod 5 comprises a giant magnetostrictive rod 2, and a movable yoke 3 and an actuator rod 4 integrally connected to the giant magnetostrictive rod 2. One end of the giant magnetostrictive rod 2 is a fixed end 2A, and the other end thereof is a free end 2B. The magnetic field generation coil 6 applies a magnetic field in an axial direction to the giant magnetostrictive rod 2 of the drive rod 5. The diaphragm 7 is fixed to the drive rod 5 on the side of the free end 2B through an attachment disk 7A.

In this speaker 1, the axial vibration (expansion and contraction) of the giant magnetostrictive rod 2 is transmitted to the diaphragm 7 through the movable yoke 3 and the actuator rod 4, so that sound is output from the diaphragm 7.

In such a conventionally known speaker 1, however, it was necessary to dispose the speaker over listener's head or the like and set the diaphragm 7 to the orientation of a listener, in order to efficiently transmit sound to the listener. Thus, there were problems that an installation location was restricted, and predetermined installation space was necessary. There was also a problem that an area to which sound was transmitted was restricted to a direction to which the diaphragm 7 was oriented.

### SUMMARY OF THE INVENTION

In view of the foregoing problems, various exemplary embodiments of this invention provide a speaker which can save installation space and transmit sound to a wide area.

The inventor has invented a speaker which can save installation space and transmit sound to a wide area as a result of diligent research.

That is, the present invention described below allows the aforementioned objects to be achieved.

(1) A speaker comprising a floor or road approximately in the shape of a board, the floor or road being able to vibrate in the direction of thickness; and a vibration device disposed under the floor or road, wherein the vibration device vibrates the floor or road to emit sound from the surface of the floor or road.

(2) The speaker according to (1), wherein the vibration device also functions as a pressure sensor for detecting variation in pressure applied through the floor or road.

(3) The speaker according to (1) or (2), wherein the vibration device also functions as an electric power plant for generating electric power on the basis of pressure applied through the floor or road.

(4) The speaker according to any one of (1) to (3), wherein: the floor is composed of the top face of a box; and the vibration device is disposed in the inner space of the box.

(5) The speaker according to (4), wherein the floor is supported by a base pole approximately in the shape of a rod, and the base pole is disposed in the inner space of the box.

(6) The speaker according to any one of (1) to (5), wherein the vibration device comprises: a magnetostrictive rod approximately in the shape of a rod, the magnetostrictive rod having a magnetostrictive member, and one end of the magnetostrictive rod being fixed to a mass member; and a coil disposed around the magnetostrictive rod.

(7) The speaker according to (6), wherein: the vibration device has a plurality of coils arranged in an axial direction of the magnetostrictive rod along the magnetostrictive rod; and the vibration device simultaneously drives each of the coils at different frequencies to make the floor or road perform multiple vibration at a plurality of kinds of frequencies.

(8) The speaker according to (6) or (7), wherein the magnetostrictive member is composed of a giant magnetostrictive member made of a giant magnetostrictive material.

According to the present invention, the speaker has the superior effects of saving installation space and transmitting sound to a wide area.

To solve the foregoing problems, the speaker according to the various exemplary embodiments of the present invention has a vibration device disposed under a floor or road approximately in the shape of a board which can vibrate in the direction of thickness. The vibration device vibrates the floor or road, so that sound is emitted from the surface of the floor or road.

In the present invention, the “floor” is not limited to a floor of a building, but includes a floor of a vehicle and the like.

### BRIEF DESCRIPTION OF THE DRAWINGS

Various exemplary embodiments of the present invention will be described in detail with reference to the accompanying drawings, wherein:

FIG. 1 is a schematic side sectional view showing a speaker according to a first exemplary embodiment of the present invention;

FIG. 2 is a sectional view taken along the line II-II of FIG. 1;

FIG. 3 is a schematic side sectional view showing a speaker according to a second exemplary embodiment of the present invention;

FIG. 4 is a schematic side sectional view showing a speaker according to a third exemplary embodiment of the present invention;

FIG. 5 is a schematic side sectional view showing a speaker according to a fourth exemplary embodiment of the present invention; and

FIG. 6 is a schematic side sectional view showing a conventional speaker.

### DETAILED DESCRIPTION OF THE PREFERRED EMBODIMENT

Speakers according to first to fourth exemplary embodiments of the present invention will be hereinafter described in detail with reference to the drawings.

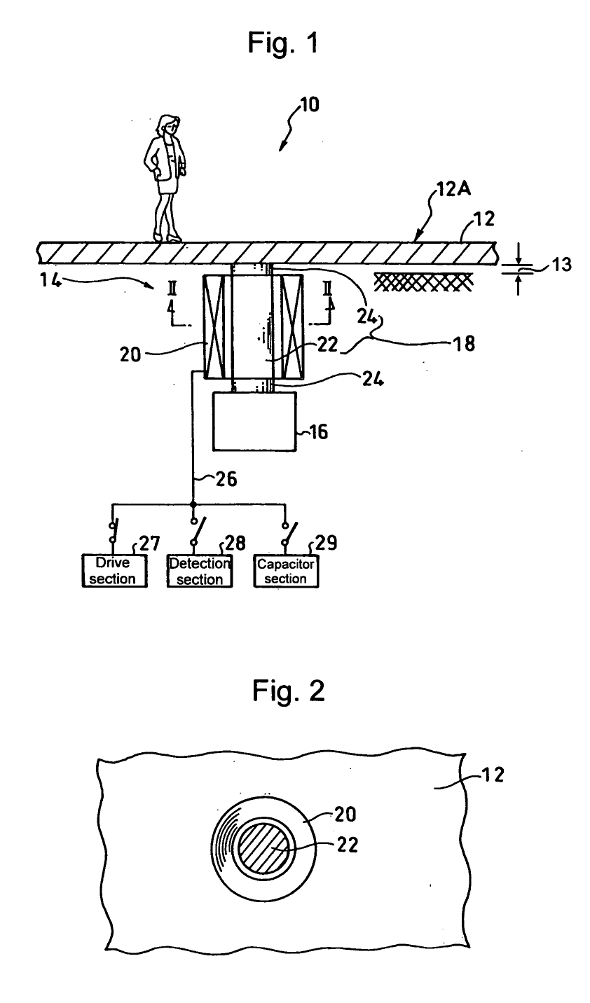

Referring to FIGS. 1 and 2, a speaker 10 according to a first exemplary embodiment comprises a vibration device 14 which is disposed under a floor 12 approximately in the shape of a board. The floor 12 can vibrate in the direction of thickness. For convenience of explanation, the vibration device 14 is illustrated in the drawing under magnification. There is a material with lower elasticity (softer material) than the floor 12, or a clearance space 13 under the floor 12 at least to a constant extent including a connection section to the vibration device 14, in order not to restrain the vibration of the floor 12 in a downward direction. In the case of the clearance space 13, the thickness thereof may be at least 10 μm. Examples of the material with lower elasticity include rubbers, resin foams, sands, and the like.

The vibration device 14 comprises a giant magnetostrictive rod 18 approximately in the shape of a rod, and a coil 20. The lower end of the giant magnetostrictive rod 18 is connected to a mass member 16. The coil 20 is disposed around the giant magnetostrictive rod 18.

When the giant magnetostrictive rod 18 is driven to be expanded and contracted in an axial direction, the mass member 16 makes displacement caused by expansion and contraction of the rod occur only on the side of the floor 12. It is preferable that a member having a mass at which the mass member 16 hardly vibrates if vibration occurs due to the expansion and contraction of the giant magnetostrictive rod 18, should be used as the mass member 16. For example, the mass member 16a should have a mass of at least approximately 100 to 200 times the mass of the giant magnetostrictive rod 18. In other words, it is preferable that the mass member 16 have such a mass as to exert an approximately several hundreds times inertial force with respect to a force which the giant magnetostrictive rod 18 generates during the expansion and contraction. Thus, the foundation of a building, a lower board of a double floor, or the like may be available as the mass member 16 in addition to a weight.

In this exemplary embodiment, the giant magnetostrictive rod 18 fixed to the mass member 16 comprises a giant magnetostrictive member 22 approximately in the shape of a rod, and two magnets 24 approximately in the shape of a disk. The magnets 24 are disposed on respective axial ends of the giant magnetostrictive member 22. The giant magnetostrictive rod 18 is so disposed that the upper end thereof can make contact with the bottom face of the floor 12, for the purpose of transmitting the axial vibration of the giant magnetostrictive rod 18 to the floor 12.

The giant magnetostrictive member 22 is made of a giant magnetostrictive material. The “giant magnetostrictive material” refers to a magnetostrictive material made of a powder sintered alloy or a single crystal alloy the main ingredient of which is a rare earth element, a particular transition metal, and/or the like (for example, terbium, dysprosium, iron, and the like). The magnetostrictive material has the characteristic of being largely displaced (Joule effect) when a magnetic field is applied from outside. The magnetostrictive material also has a characteristic that the magnetic permeability or the amount of remanent magnetization largely varies (Villari effect) when the magnetostrictive material is deformed by receiving stress from outside.

The coil 20 is connectable to each of a drive section 27, a detection section 28, and a capacitor section 29 through leads 26. A not illustrated switch can switch the connection between the coil 20 and the drive section 27, the detection section 28, or the capacitor section 29. As the capacitor section 29, for example, a rechargeable battery, a capacitor, or the like is available.

Then, the operation of the speaker 10 according to the first exemplary embodiment will be described.

When the drive section 27 is connected to the coil 20 and a drive signal such as a sound signal is input from the drive section 27 to the coil 20, a magnetic field in the axial direction is applied to the giant magnetostrictive rod 18 in response to the drive signal. Since the giant magnetostrictive rod 18 vibrates (expands and contracts) in the axial direction due to a magnetostrictive effect, the floor 12 vibrates in the direction of thickness, so that a floor surface 12A can emit sound.

The vibration device 14 according to the first exemplary embodiment also functions as a pressure sensor which can detect variation in pressure applied through the floor 12. To be more specific, taking a case where a person passes on the floor 12, for example, pressure in the axial direction is applied from the floor 12 to the giant magnetostrictive rod 18. Thus, the giant magnetostrictive rod 18 is deformed in the axial direction, and hence the magnetic permeability or the amount of remanent magnetization therein varies. Accordingly, the detection section 28 detects variation in the magnetic permeability or the amount of remanent magnetization of the giant magnetostrictive rod 18 as variation in the value of inductance of the coil 20, so that the vibration device 14 can detect variation in pressure applied to the floor 12. Therefore, it is also possible to make the speaker 10 according to the first exemplary embodiment function as, for example, an alarm for detecting the intrusion of a burglar.

Furthermore, the vibration device 14 according to the first exemplary embodiment also functions as an electric power plant which can generate electric power on the basis of pressure applied through the floor 12. To be more specific, when, for example, a person passes on the floor 12, pressure in the axial direction is applied from the floor 12 to the giant magnetostrictive rod 18. Thus, the giant magnetostrictive rod 18 is deformed in the axial direction, and hence voltage is induced and electric power is generated in the coil 20. The capacitor section 29 accumulates the electric power generated in the coil 20, so that the speaker 10 according to the first exemplary embodiment functions as the electric power plant.

The speaker 10 according to the first exemplary embodiment has the vibration device 14 disposed under the floor 12 approximately in the shape of a board which can vibrate in the direction of thickness. Since the vibration device 14 vibrates the floor 12, sound is emitted from the floor surface 12A. Thus, the floor 12 can function as a diaphragm of the speaker. Therefore, it is possible to save space and transmit sound to a wide area.

Especially, the vibration device 14 has the giant magnetostrictive rod 18 approximately in the shape of a rod, and the coil 20 disposed around the giant magnetostrictive rod 18. The giant magnetostrictive rod 18 has the giant magnetostrictive member 22, and one end of the giant magnetostrictive rod 18 is fixed on the mass member 16. Thus, the vibration device 14 can generate large stress, and hence it is possible to easily vibrate a floor or road with large mass.

The vibration device 14 also functions as the pressure sensor which can detect variation in pressure applied through the floor 12, and the electric power plant which can generate electric power on the basis of pressure applied through the floor 12. Thus, the vibration device 14 is available as the pressure sensor and the electric power plant, when the vibration device 14 is not used as the speaker. Therefore, the vibration device 14 can offer high convenience.

Furthermore, the giant magnetostrictive rod 18 has the giant magnetostrictive member 22 made of the giant magnetostrictive material. Accordingly, it is possible to increase the amount of vibration as a vibration device, improve detection sensitivity as a pressure sensor, and increase the amount of electric power generation as an electric power plant.

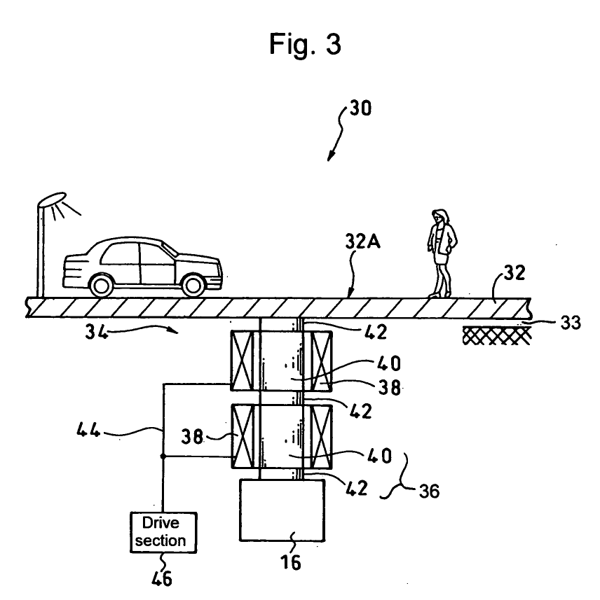

Next, a speaker 30 according to a second exemplary embodiment of the present invention will be described in detail with reference to FIG. 3.

As shown in the drawing, the speaker 30 according to the second exemplary embodiment has a vibration device 34 disposed under a road 32 approximately in the shape of a board. The road 32 can vibrate in the direction of thickness. In the drawing, the same reference number as that of the speaker 10 according to the foregoing first exemplary embodiment refers to an identical portion, and the description thereof will be omitted. As in the case of the first exemplary embodiment, there is a clearance space 33 under the road 32 to enable the vibration of the road 32. Sands, rubbers, or the like may be provided instead of the clearance space 33.

The vibration device 34 comprises a giant magnetostrictive rod 36 approximately in the shape of a rod, and a plurality of (two, in this exemplary embodiment) coils 38 arranged in the axial direction of the giant magnetostrictive rod 36 along the giant magnetostrictive rod 36. One end of the giant magnetostrictive rod 36 is fixed on a mass member 16.

The giant magnetostrictive rod 36 comprises two giant magnetostrictive members 40 approximately in the shape of a rod, and three magnets 42 approximately in the shape of a disk. The magnets 42 are disposed on both axial ends of the giant magnetostrictive members 40. The coils 38 are connected to a drive section 46 through leads 44.

Then, the operation of the speaker 30 according to the second exemplary embodiment will be described.

When a drive signal such as a sound signal is input from the drive section 46 to the coils 38, a magnetic field in the axial direction is applied to the giant magnetostrictive rod 36 in response to the drive signal. Since the giant magnetostrictive rod 36 vibrates (expands and contracts) in the axial direction due to a magnetostrictive effect, the road 32 vibrates in the direction of thickness, so that a road surface 32A can emit sound.

In the vibration device 34 according to the second exemplary embodiment, the two coils 38 are driven at the same time by respective drive signals with different frequencies. Thus, the giant magnetostrictive members 40 vibrate with different frequencies in accordance with the drive frequencies of the two coils 38. As a result, the giant magnetostrictive rod 36 performs multiple vibration on the whole with a plurality of kinds of frequencies. Accordingly, if a predetermined drive signal is input to one coil 38, and another drive signal which is a delay signal of the predetermined drive signal is input to the other coil 38, it is possible to easily realize an echo effect and the like.

The giant magnetostrictive member 40 is a member with extremely low magnetic permeability. Thus, it is possible to extremely reduce the interference of magnetic fields generated by the two coils 38. In other words, each of the giant magnetostrictive members 40 is driven only by the coil 38 disposed around it, and the multiple vibration from the giant magnetostrictive members 40 is transmitted to the road 32 with hardly interfering with each other.

The speaker 30 according to the second exemplary embodiment has the vibration device 34 disposed under the road 32 approximately in the shape of a board which can vibrate in the direction of thickness. Since the vibration device 34 vibrates the road 32, sound is emitted from the road surface 32A. Thus, the road 32 functions as a diaphragm of the speaker. Therefore, it is possible to save installation space and transmit sound to a wide area.

In the vibration device 34, the plurality of coils 38 are arranged in the axial direction of the giant magnetostrictive rod 36 along the giant magnetostrictive rod 36. Thus, the vibration device 34 can make the road 32 perform the multiple vibration with a plurality of kinds of frequencies, by simultaneously driving each of the coils 38 with different frequencies. Accordingly, it is possible to output the multiple vibration with the plurality of kinds of frequencies.

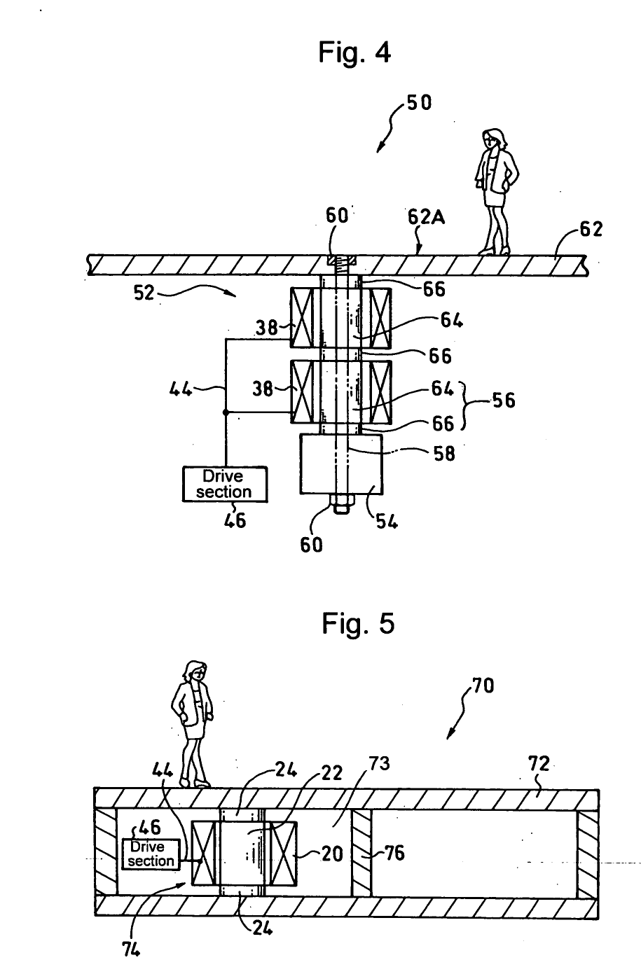

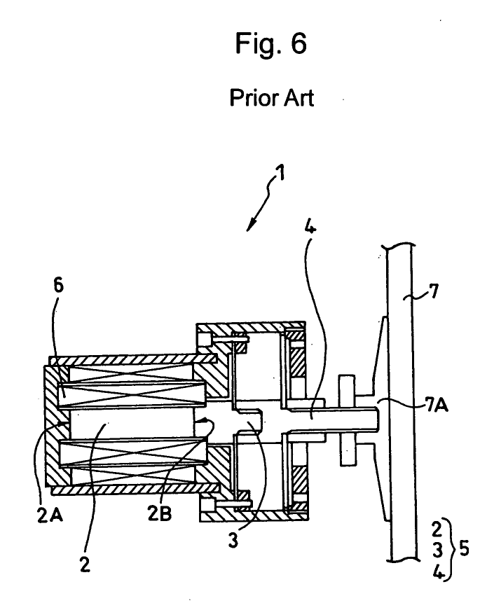

Next, a speaker 50 according to a third exemplary embodiment of the present invention will be described in detail with referring to FIG. 4.

As shown in the drawing, in a vibration device 52 applied to the speaker 50 according to the third exemplary embodiment, a mass member 54 and a giant magnetostrictive rod 56 which approximately take the shape of a cylinder are used instead of the mass member 16 and the giant magnetostrictive rod 36 of the vibration device 34 according to the foregoing second exemplary embodiment. In the drawing, the same reference number as that of the speaker 30 according to the second exemplary embodiment refers to an identical portion, and the description thereof will be omitted.

The mass member 54 and the giant magnetostrictive rod 56 which are approximately in the shape of a cylinder are fixed to a floor 62 with a single bolt 58 penetrating through the inner spaces thereof, and two nuts 60 screwed to respective ends of the bolt 58. The giant magnetostrictive rod 56 comprises two giant magnetostrictive members 64 and three magnets 66 which are disposed on respective axial ends of the giant magnetostrictive members 64.

According to the speaker 50 in the third exemplary embodiment, a preload is applied in the axial direction of the giant magnetostrictive rod 56 by the bolt 58 and the nuts 60. Accordingly, it is possible to further increase the amount of vibration, as compared with the speaker 30 according to the second exemplary embodiment.

The mass member 54 and the giant magnetostrictive rod 56 are molded approximately in the shape of a cylinder, so that the mass member 54 and the giant magnetostrictive rod 56 are easily attached to a floor or road with the bolt 58, the nuts 60, and the like.

Next, a speaker 70 according to a fourth exemplary embodiment of the present invention will be described in detail with referring to FIG. 5.

As shown in the drawing, in the speaker 70 according to the fourth exemplary embodiment, a floor 72 which is composed of the top face of a box is used instead of the floor 12 of the speaker 10 according to the foregoing first exemplary embodiment. In the drawing, the same reference number as that of the speaker 10 according to the first exemplary embodiment refers to an identical portion, and the description thereof will be omitted.

A vibration device 74 for vibrating the floor 72 in the direction of thickness is disposed in the inner space 73 of the box. The floor 72 is supported by a base pole 76 approximately in the shape of a rod which is disposed in the inner space 73 of the box.

In the speaker 70 according to the fourth exemplary embodiment, the floor 72 is composed of the top face of the box, and the vibration device 74 is disposed in the inner space 73 of the box. Therefore, it is possible to increase outputted sound, and move the speaker.

The floor 72 is supported by the approximately rod-shaped base pole 76 disposed in the inner space 73 of the box, so that it is possible to further increase the amount of vibration of the floor 72.

The shape, structure, and the like of a speaker according to the present invention are not limited to those of the speakers 10, 30, 50, and 70 according to the foregoing first to fourth exemplary embodiments. For example, a magnetostrictive member made of a magnetostrictive material may be used instead of the giant magnetostrictive member, as long as a vibration device can obtain the sufficient amount of vibration.

The vibration device is not limited to a device using a magnetostrictive member, but may be a device using a piezoelectric member or the like.

In other words, a speaker according to the present invention has a vibration device disposed under a floor or road approximately in the shape of a board which can vibrate in the direction of thickness. The speaker can emit sound from a floor surface or a road surface because the vibration device vibrates the floor or road.

1. A speaker comprising
a floor or road approximately in the shape of a board, the floor or road being able to vibrate in the direction of thickness; and
a vibration device disposed under the floor or road,
wherein the vibration device vibrates the floor or road to emit sound from the surface of the floor or road.

2. The speaker according to claim 1, wherein
the vibration device also functions as a pressure sensor for detecting variation in pressure applied through the floor or road.

3. The speaker according to claim 1, wherein
the vibration device also functions as an electric power plant for generating electric power on the basis of pressure applied through the floor or road.

4. The speaker according to claim 2, wherein
the vibration device also functions as an electric power plant for generating electric power on the basis of pressure applied through the floor or road.

5. The speaker according to claim 1, wherein:
the floor is composed of the top face of a box; and
the vibration device is disposed in the inner space of the box.

6. The speaker according to claim 2, wherein:
the floor is composed of the top face of a box; and
the vibration device is disposed in the inner space of the box.

7. The speaker according to claim 3, wherein:
the floor is composed of the top face of a box; and
the vibration device is disposed in the inner space of the box.

8. The speaker according to claim 5, wherein
the floor is supported by a base pole approximately in the shape of a rod, and the base pole is disposed in the inner space of the box.

9. The speaker according to claim 6, wherein
the floor is supported by a base pole approximately in the shape of a rod, and the base pole is disposed in the inner space of the box.

10. The speaker according to claim 7, wherein
the floor is supported by a base pole approximately in the shape of a rod, and the base pole is disposed in the inner space of the box.

11. The speaker according to claim 1, wherein
the vibration device comprises:
a magnetostrictive rod approximately in the shape of a rod, the magnetostrictive rod having a magnetostrictive member, and one end of the magnetostrictive rod being fixed to a mass member; and
a coil disposed around the magnetostrictive rod.

12. The speaker according to claim 2, wherein
the vibration device comprises:
a magnetostrictive rod approximately in the shape of a rod, the magnetostrictive rod having a magnetostrictive member, and one end of the magnetostrictive rod being fixed to a mass member; and
a coil disposed around the magnetostrictive rod.

13. The speaker according to claim 3, wherein
the vibration device comprises:
a magnetostrictive rod approximately in the shape of a rod, the magnetostrictive rod having a magnetostrictive member, and one end of the magnetostrictive rod being fixed to a mass member; and
a coil disposed around the magnetostrictive rod.

14. The speaker according to claim 5, wherein
the vibration device comprises:
a magnetostrictive rod approximately in the shape of a rod, the magnetostrictive rod having a magnetostrictive member, and one end of the magnetostrictive rod being fixed to a mass member; and
a coil disposed around the magnetostrictive rod.

15. The speaker according to claim 8, wherein
the vibration device comprises:
a magnetostrictive rod approximately in the shape of a rod, the magnetostrictive rod having a magnetostrictive member, and one end of the magnetostrictive rod being fixed to a mass member; and
a coil disposed around the magnetostrictive rod.

16. The speaker according to claim 11, wherein:
the vibration device has a plurality of coils arranged in an axial direction of the magnetostrictive rod along the magnetostrictive rod; and
the vibration device simultaneously drives each of the coils at different frequencies to make the floor or road perform multiple vibration at a plurality of kinds of frequencies.

17. The speaker according to claim 11, wherein
the magnetostrictive member is composed of a giant magnetostrictive member made of a giant magnetostrictive material.

18. The speaker according to claim 16, wherein
the magnetostrictive member is composed of a giant magnetostrictive member made of a giant magnetostrictive material.
